(19) United States
(12) Patent Application Publication
(10) Pub. No.: US 2012/0097720 A1
(43) Pub. Date: Apr. 26, 2012

(54) UTILITY HOLDER FOR MOBILITY ASSISTANCE DEVICE

(76) Inventor: Robert Lee, Shasta Lake, CA (US)

(21) Appl. No.: 12/910,838

(22) Filed: Oct. 24, 2010

(51) Int. Cl. B60R 9/00; F16B 2/20; F16B 35/00; F16M 13/02; A44B 18/00

(52) U.S. Cl. 224/407; 248/220.21; 248/205.2; 248/222.14

(57) ABSTRACT

The present invention relates to a holder for items such as a cane or umbrella which attaches to a wheelchair or walker to allow easy access to the items when required for use. The present invention provides a utility holder comprising a tubular body extending vertically with a hollowed center, an opening at a top portion of the tubular body where the opening enables the tubular body to accept an elongated item, a cap attached to a base of the tubular body, and a set of attachment means affixed to the tubular body wherein the set of attachment means enable the tubular body to attach to a mobility assistance device and carry the elongated item.

### BACKGROUND OF THE INVENTION

1. Field of the Invention

The present invention relates to a holder for items such as a cane or umbrella which attaches to a wheelchair or walker to allow easy access to the items when required for use.

2. Description of Related Art

Many individuals require the use of a walker or wheelchair to aid in mobility assistance, whether they are recovering from an injury, have a permanent disability or cannot support their own weight. Many times these individuals require the assistance of a cane or walking stick when not using the wheelchair or walker. Often when traveling in a wheelchair the person places their cane upon their lap until needed for use. This is inconvenient because their hands are occupied and cannot reach or grab the things they need. Likewise, a cane is difficult to carry when using a walker, and causes more hassle than assistance.

Furthermore, sometimes these people may need a place to rest or hold their umbrella when indoors. Some public establishments offer umbrella holders by the entrances for their guests to leave their umbrella while dining or shopping. These public umbrella holders are not secure because they are not monitored and are at a remote distance from the user. The umbrella may be easily stolen, lost or forgotten.

Some current devices offer assistance to carry a cane or umbrella by attaching them to a wheelchair. For example, U.S. Pat. No. 5,524,657 by Pey-en Jih discloses a Universal Attachment for Walking Assistive Devices wherein a hardware mounting device is permanently attached to a walker. The hardware mounting device provides a set of clamps to allow the walker to carry a cane or set of crutches. This hardware is useful but requires permanent attachment to the walker and assembly is complicated.

Likewise, U.S. Pat. No. 7,021,324 by Charles L. Clay discloses a Walker with Can Holder and Non-catch Castors wherein an upper bracket and a lower bracket secure a cane against a walker. The upper bracket is similar to a clamp to accept the stick portion of the cane whereas the lower bracket is similar to a cup to accept the base of the cane. While this device is more easily attached to the walker it does not allow for an alternative item to be inserted in to the brackets.

It would be beneficial in the art to provide a cane holder that attaches to a walker or wheelchair that is easily mounted and dismounted for use. It would also be desirable in the art to provide a cane holder that enables a variety of items to be inserted and carried on the walker.

### SUMMARY OF THE INVENTION

In view of the foregoing disadvantages inherent in the prior art, the general purpose of the present disclosure is to provide a utility holder comprising a tubular body extending vertically with a hollowed center, an opening at a top portion of the tubular body where the opening enables the tubular body to accept an elongated item, a cap attached to a base of the tubular body, and a set of attachment means affixed to the tubular body wherein the set of attachment means enable the tubular body to attach to a mobility assistance device and carry the elongated item.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a utility holder in accordance with an exemplary embodiment of the present invention;

FIG. 2 depicts a perspective view of a utility holder attached to a walker in accordance with an exemplary embodiment of the present invention; and

FIG. 3 depicts a side view of a utility holder attached to a walker in accordance with an exemplary embodiment of the present invention.

Like reference numerals refer to like parts throughout the description of several views of the drawings.

### DETAILED DESCRIPTION OF THE DRAWINGS

The present invention relates to a holder for items such as a cane or umbrella which attaches to a wheelchair or walker to allow easy access to the items when required for use. The present invention discloses a utility holder which quickly and easily mounts to a walker or wheelchair to hold the cane or umbrella upright for transport. The utility holder may be attached with a variety of fasteners including a set of hook and loop fasteners, a set of bolts or a set of mounting clamps. The utility holder allows the users to quickly access the cane or umbrella without having to search for it if in a remote location, or requiring them to uncomfortably bend or reach for an item that may have fallen or rolled away. The utility holder may anchor canes and umbrellas of various sizes, and provides a storage location for one or more of the items at a time.

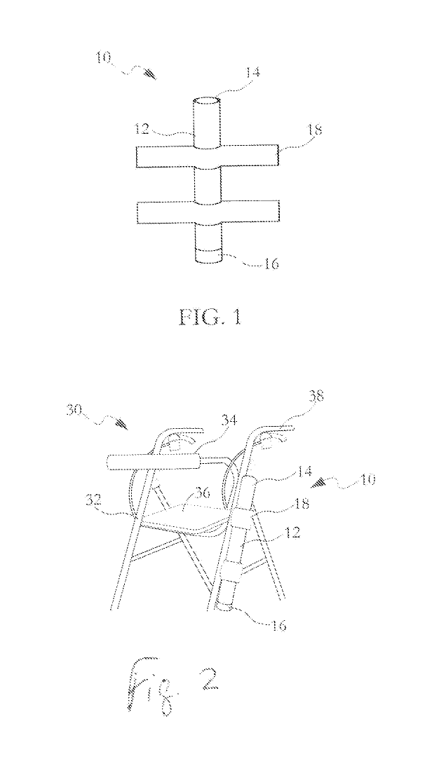

Turning now to the drawings, referring to FIG. 1, a perspective view of a utility holder (10) is shown in accordance with an exemplary embodiment of the present invention. The utility holder (10) consists of a tubular body (12) extending vertically approximately 12-24 inches in length, with a generally hollowed center. The tubular body (12) may have a cylindrical shape (as shown), a rectangular shape or even a triangular shape. The colors, shapes and lengths available for the tubular body (12) may vary depending on the preferences and likes of a user.

At a top end of the tubular body (12) is an opening (14), and at an opposing end or base is a cap (16). The opening (14) allows a plurality of elongated items to slide into the tubular body without restriction or interferences. The cap (16) prevents any of the plurality of elongated items from falling or sliding through the tubular body (12). The cap (16) may be removed to clean the tubular body (12) or remove any debris collected in the bottom of the utility holder (10). The plurality of elongated items may be a cane, a walking stick or an umbrella. One or more of the elongated items may be placed in the utility holder at one time to provide a convenient storage device for the user while using the walker. By keeping the elongated items close to the user the items will not be stolen, lost or forgotten.

To secure the utility holder (10) to another device a set of attachment means (18) may be used. The set of attachment means (18) may be a set of hook and loop fasteners more commonly referred to as Velcro®. The set of hook and loop fasteners may enable quick and easy attachment and removal of the utility holder (10) to a variety of different devices specifically mobility assistance devices. Alternatively, the set of attachment means (18) may be a set of bolts for a permanent mounting of the utility holder (10). The set of bolts may prevent any movement of the utility holder (10) after mounting. Finally, the set of attachment means may be a set of mounting clips to enable the tubular body (12) to easily snap into place. The set of attachment means (18) may enable the utility holder (10) to be easily transferred from one mobility assistance device to another.

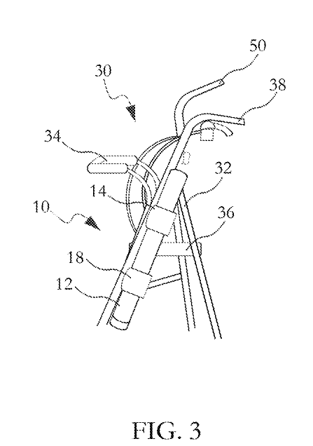

Referring now to FIG. 2, a perspective view of the utility holder (10) is shown attached to a walker (30) in accordance with an exemplary embodiment of the present invention. The walker (30) may comprise a set of standard features associated with a rolling walker, including a frame (32), a backrest (34), a seat (36) and a handle (38). The walker (30) is normally used to assist a person with mobility issues to maneuver from location to another. The utility holder (10) may be fastened along a side of the frame (32) for easy access to the plurality of elongated items. For example, the benefit of mounting the utility holder (10) along the side of the walker (30) is to allow quick access to the cane in case the user sits and needs assistance standing, the cane is immediately at their side. Alternatively, the user may be at a restaurant or other establishment and need to find a location to store their umbrella, the utility holder (10) serves exactly that purpose.

Another option for mounting the utility holder (10) may be to attach it to a wheelchair. Many times a wheelchair user does not require the wheelchair all of the time, and often uses a cane when not seated in the chair. The utility holder (10) may assist these users by providing a cane holder or umbrella holder to free use of their hands while seated.

Referring to FIG. 3, a side view of the utility holder (10) mounted to the walker (30) is shown in accordance with an exemplary embodiment of the present invention. The utility holder (10) is illustrated with a cane (50) inserted within the tubular body (12). The cane (50) may simply slide into the opening (14) and rest at an angle within the utility holder (10). When needed for use the user removes the cane (50) which is conveniently at the same angle and relative height of the walker handle (38).

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A utility holder comprising:
a tubular body extending vertically with a hollowed center;
an opening at a top portion of said tubular body where said opening enables said tubular body to accept an elongated item;
a cap attached to a base of said tubular body; and
a set of attachment means affixed to said tubular body wherein said set of attachment means enable said tubular body to attach to a mobility assistance device and carry said elongated item.

2. The utility holder of claim 1, wherein said set of attachment means is a set of hook and loop fasteners.

3. The utility holder of claim 1, wherein said set of attachment means is a set of bolts.

4. The utility holder of claim 1, wherein said set of attachment means are a set of mounting clips.

5. The utility holder of claim 1, wherein said cap is removable to allow cleaning of said base of said utility holder.

6. The utility holder of claim 1, wherein said mobility assistance device is a walker.

7. The utility holder of claim 1, wherein said mobility assistance device is a wheelchair.

8. The utility holder of claim 1, wherein said elongated item is a cane

9. The utility holder of claim 1, wherein said elongated item is an umbrella.
